(19) United States
(12) Patent Application Publication
(10) Pub. No.: US 2007/0249389 A1
(43) Pub. Date: Oct. 25, 2007

(54) Cellular Phone Device

(75) Inventor: Mihoko Hotta, Tokyo (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/577,543

(22) PCT Filed: Oct. 24, 2005
(86) PCT No.: PCT/JP05/19852

§ 371 Date: Apr. 19, 2007

(30) Foreign Application Priority Data
Oct. 25, 2004 (JP) 2004-309413

(51) Int. Cl. H04M 1/00

(52) U.S. Cl. 455/552.1

(57) ABSTRACT

A cellular phone device is provided that improves the usability for the user when photographing a self-portrait while protecting an imaging unit from being soiled and damaged, by covering imaging unit with the following structure. That is, the phone device has a first casing, a second casing, and a third casing. One side of the first casing rotatably supports the second casing, and the other side of the first casing slidably supports the third casing. The first casing is loaded with the imaging unit, and the imaging unit is contained in the third casing when the third casing is slid along the first casing and partially overlaps with the first casing.

### TECHNICAL FIELD

The present invention relates to a cellular phone device, particularly to a camera-equipped folding cellular phone device for many different uses.

### BACKGROUND ART

In recent years, camera-equipped cellular phone devices have been practically used that are folding cellular phone devices equipped with a CCD camera or CMOS camera. Among these phone devices, one is known that has a sliding casing for protecting the display and the imaging unit equipped from being soiled and damaged. Another cellular phone device is disclosed in Japanese Patent Unexamined Puhlieation No. 2004-72285, for example, that has improved the usability for the user through cooperation with sliding operation.

However, the above-described conventional cellular phone device is structured so that the display unit is fixed in one direction with respect to the camera direction and thus is not arbitrarily rotatable. Consequently, the user is unable to photograph a self-portrait, while previewing.

### SUMMARY OF THE INVENTION

The present invention, in view of such problems, provides a cellular phone device that improves the usability for the user when photographing a self-portrait while protecting the imaging unit from being soiled and damaged, through sliding the casing that works as a cover when the camera is not used, to cover the camera.

The present invention further provides a cellular phone device that improves the usability in photographing a self-portrait through executing zooming and photographing operation with a touch-panel input unit.

A cellular phone device of the present invention has first, second, and third casings. One side of the first casing rotatably supports the second casing, and the other side of the first casing slidably supports the third casing. The first casing is equipped with a camera, which is contained in the third casing when it is slided along the first casing to partially overlap with each other. The second casing is equipped with a display unit, which displays information according to operation of the cellular phone device in a state of the second casing rotated by an arbitrary angle relatively to the first casing.

Such makeup improves the usability for the user when photographing a self-portrait while protecting the imaging unit from being soiled and damaged through sliding the casing that works as a cover when the camera is not used, to cover the camera.

A cellular phone device of the present invention has first, second, and third casings. One side of the first casing rotatably supports the second casing, and the other side of the first casing slidably supports the third casing. The first casing is equipped with a camera, which is contained in the third casing when it is slided along the first casing to partially overlap with each other. The second casing is equipped with a display unit, which displays information according to operation of the cellular phone device in a state of the second casing rotated by an arbitrary angle relatively to the first casing. One surface of the third casing is provided with a key operation unit, and the surface opposite to that provided with the key operation unit is provided with a touch-panel input unit. The user can key-input from the key operation unit on the third casing while the user views the display unit on the second casing by rotating the first and the third casings, with the display unit on the second casing being in front of the user. The user can as well touch-input from the touch-panel input unit on the third casing while the user views the display unit on the second casing.

Such makeup improves the usability when photographing a self-portrait through executing zooming and photographing operation with the touch-panel input unit.

A cellular phone device of the present invention has first, second, and third casings. One side of the first casing rotatably supports the second casing, and the other side of the first casing slidably supports the third casing. The first casing is equipped with a camera, which is contained in the third casing when it is slided along the first casing to partially overlap with each other. The second casing is equipped with a display unit, which displays information according to operation of the cellular phone device in a state of the second casing rotated by an arbitrary angle relatively to the first casing. The second casing is equipped with a display unit. One surface of the third casing is provided with a key operation unit, and the surface opposite to that provided with the key operation unit is provided with a touch-panel input unit. The user can use the cellular phone device by selecting one of the following. That is, the user can key-input from the key operation unit on the third casing while the user views the display unit on the second casing by rotating the third casing, with the display unit on the second casing being in front of the user; alternatively the user can touch-input from the touch-panel input unit on the third casing while the user views the display unit on the second casing.

Such makeup improves the usability when photographing a self-portrait through executing zooming and photographing operation with the touch-panel input unit.

As described above, the cellular phone device according to the present invention improves the usability for the user when photographing a self-portrait while protecting the imaging unit from being soiled and damaged through sliding the casing that works as a cover when the camera is not used, to cover the camera, as well as the cellular phone device improves the usability when photographing a self-portrait through executing zooming and photographing operation with the touch-panel input unit.

### BRIEF DESCRIPTION OF DRAWINGS

FIG. 1A is an external view of the first casing of a cellular phone device according to the first exemplary embodiment of the present invention, in the state of being contained in the third casing.

FIG. 1B is an exploded view of the cellular phone device according to the first embodiment of the present, with the third casing removed.

FIG. 2 is a block diagram illustrating the major makeup of the cellular phone device according to the first embodiment of the present invention.

FIG. 3A is an external view of the cellular phone device according to the first embodiment of the present invention, in the contracted state.

FIG. 3B is an external view of the phone device according to the first embodiment of the present invention, in the extended state.

FIG. 3C is an external view of the cellular phone device according to the first embodiment of the present invention, in the extended and rotated state.

FIG. 4 is an external view of a cellular phone device according to the second embodiment of the present invention, in the state of the third casing with its front and back reversed.

FIG. 5 is a block diagram illustrating the major makeup of the cellular phone device according to the second embodiment of the present invention.

FIG. 6 is an external view of the cellular phone device according to the second embodiment of the present invention, in the state of tripod 26 connected into tripod screw hole 9.

FIG. 7 is an external view of the cellular phone device according to the second embodiment of the present invention, in a case of photographing a self-portrait of the user.

FIG. 8A is an external view of a cellular phone device according to the third embodiment of the present invention.

FIG. 8B is an external view of the cellular phone device according to the third embodiment of the present invention, with the third casing extended.

FIG. 9A is an external view of the cellular phone device according to the third embodiment of the present invention, with the third casing extended.

FIG. 9B is an external view of the cellular phone device according to the third embodiment of the present invention, with the third casing extended and rotated.

FIG. 10 is an external view of the cellular phone device according to the third embodiment of the present invention, in a case where the device is used for a videophone.

### DETAILED DESCRIPTION OF PREFERRED EMBODIMENTS

Hereinafter, a detailed description is made for embodiments of the present invention, with reference to the related drawings.

### First Exemplary Embodiment

A cellular phone device of the embodiment is composed of first, second, and third casings. One side of the first casing slidably supports the third casing, and the other side of the first casing rotatably supports the second casing.

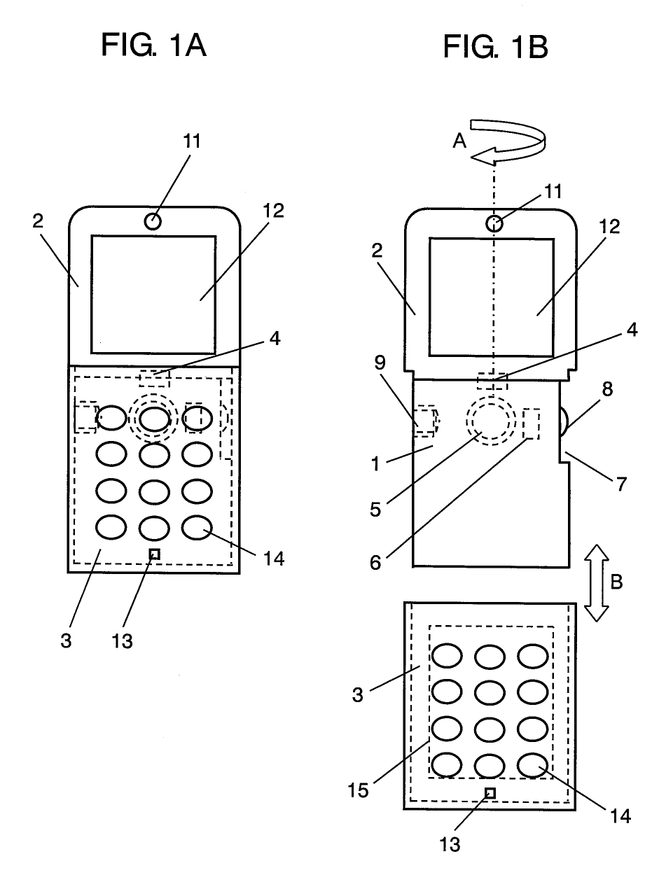

FIG. 1A is an external view of the cellular phone device according to the first embodiment of the present invention, in the state of the first casing contained in the third casing. FIG. 1B is an exploded view of the same, with the third casing removed.

First casing 1 is equipped with rotation axis 4, imaging unit 5 (e.g. a camera), lighting unit (flash) 6, recess 7, shutter button 8, and tripod screw hole 9. Second casing 2 is equipped with speaker 11 and display unit 12. Third casing 3 is equipped with microphone 13 and operation unit 14.

In the state shown in FIG. 1A, first casing 1 is covered with third casing 3. Rotation axis 4 supports second casing 2 rotatably about the first casing. Speaker 11 reproduces telephone speech, ring alert, and the like. Display unit 12 displays images recorded on the cellular phone device, menus for the cellular phone or camera function, and the like. Microphone 13 converts sound into electric signals for telephone speech and recording. Operation unit 14 includes plural buttons for operating the cellular phone device. With the cellular phone device of FIG. 1A, regular voice communication is available while first casing 1 remains contained in third casing 3.

The state of FIG. 1B shows an exploded view. Actually, however, sliding of third casing 3 stops in a state of third casing 3 partially overlapping first casing 1, thus allowing the cellular phone device to be used with first casing 1, second casing, and third casing 3, all integrated together. Lighting unit 6 emits light to increase the luminance of a subject at a low luminance level when photographing, allowing camera photographing in a dark place. Shutter button 8 is a shutter button for directing focusing and imaging. Tripod screw hole 9 is a screw hole for attaching a tripod to the cellular phone device. Imaging unit 5 takes images.

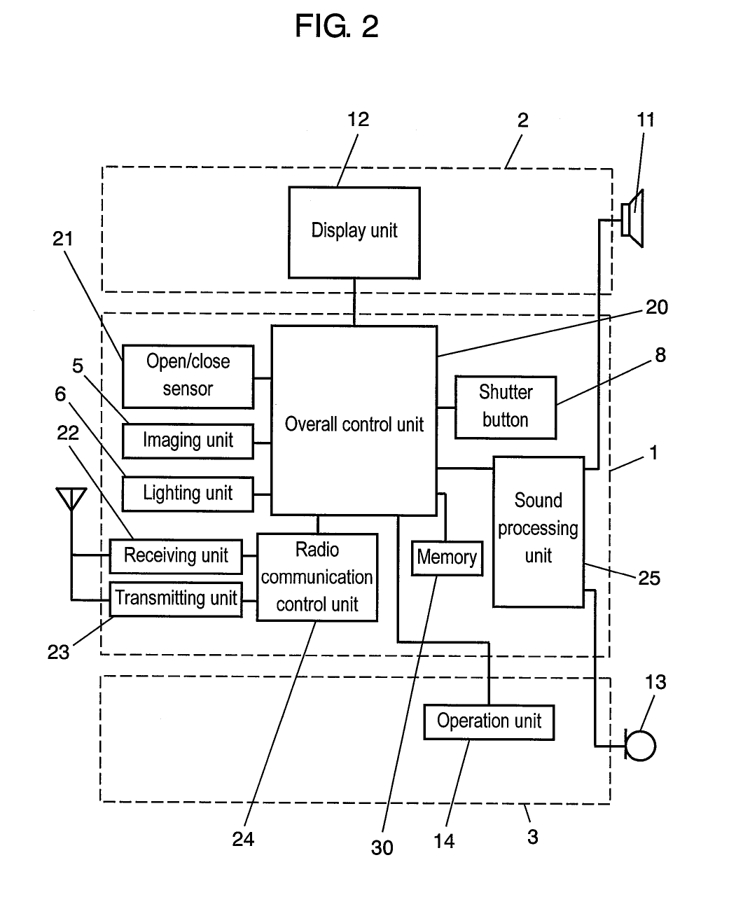

FIG. 2 is a block diagram illustrating the makeup of the cellular phone device according to the first embodiment of the present invention. First casing 1, second casing 2, and third casing 3 are shown by broken lines, and the means respectively provided in there are shown by blocks. More specifically, the makeup includes imaging unit 5, lighting unit 6, shutter button 8, speaker 11, display unit 12, microphone 13, overall control unit 20, open/close sensor 21, receiving unit 22, transmitting unit 23, radio communication control unit 24, sound processing unit 25, and memory 30.

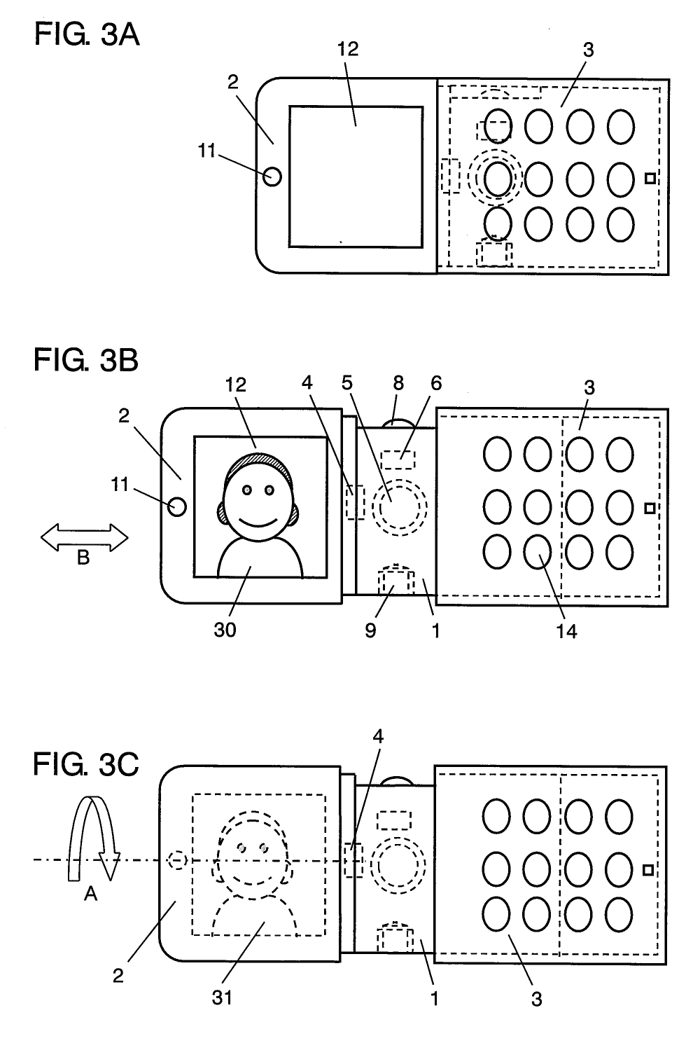

Here, a component in FIG. 2 and FIGS. 3A to 3C same as in FIG. 1 is given the same mark to omit its description.

An analog sound signal supplied from microphone 13 is converted to a digital signal by sound processing unit 25, fed into overall control unit 20, fed into radio communication control unit 24 where the digital signal is modulated, and then transmitted by transmitting unit 23 through a radio communication line. A digital sound signal transmitted from the other end of the line during telephone conversation is received by receiving unit 22, converted by radio communication control unit 24, fed into overall control unit 20, and then supplied to speaker 11 by sound processing unit 25. An image taken by imaging unit 5 as a result of shutter button 8 having been pressed is displayed on display unit 12 by overall control unit 20, and then stored in memory 30. Lighting unit 6 turns on the light according to directions from overall control unit 20. Open/close sensor 21 monitors open/close operation such as sliding and rotation of the casing, and notifies overall control unit 20 of open/close conditions when detected. Overall control unit 20 controls the display direction (e.g. tilt) of display unit 12 according to this notice.

FIGS. 3A through 3C are external views for illustrating changes of the appearance of the cellular phone device according to the first embodiment of the present invention. FIG. 3A is an external view of the cellular phone device according to this embodiment, in the contracted state. FIG. 3B is an external view of the same, with third casing 3 extended. With the cellular phone according to this embodiment, third casing 3 can be slided in the direction of arrow B within a certain range, from the state of FIG. 3A to that of FIG. 3B. In the state of FIG. 3B, display unit 12 faces the user side, and imaging unit 5 faces the side opposite to the user, thus allowing the user to photograph while monitoring subject 30 displayed on display unit 12.

FIG. 3C is an external view illustrating the state of second casing 2 rotated by 180 degrees in the direction of arrow A while maintaining third casing 3 in the extended state. Rotating in this way causes both imaging unit 5 and display unit 12 face the same direction, and thus the user can photograph a self-portrait while previewing.

In this embodiment, the description is made only for the cases where imaging unit 5 is positioned at the opposite side of display unit 12 and at the same side. However, the present invention is not limited to these cases, namely photographing can be executed with display unit 12 rotated at an arbitrary angle easy-to-view from the user.

### Second Exemplary Embodiment

Next, a description is made for the second exemplary embodiment of the present invention. A cellular phone device of the embodiment is equipped with an operation unit on one surface of the third casing and disposes a display and a touch panel on the surface opposite to that provided thereon with the operation unit.

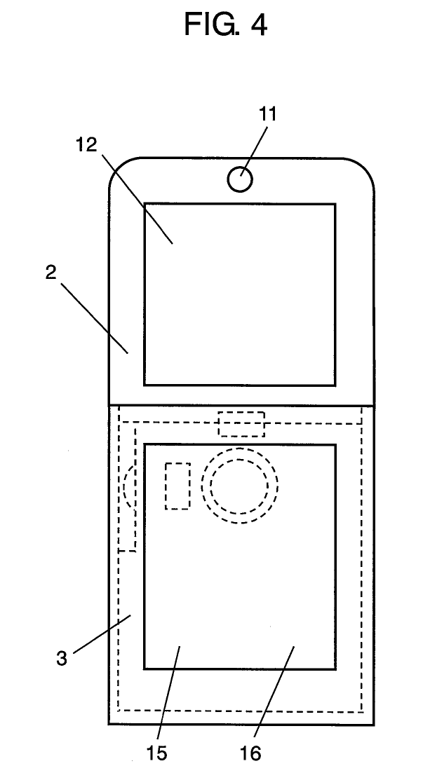

FIG. 4 is an external view of the cellular phone device according to the second embodiment of the present invention, in the state of the third casing with its front and back reversed. The cellular phone device of the embodiment shown in FIG. 4 is equipped mainly with touch-panel input unit 15 and second display unit 16. Here, both touch-panel input unit 15 and second display unit 16 are attached on the same surface.

Here, FIGS. 4, 5, 6, 7 show components common to those shown in the external view for the first embodiment, and thus the same component is given the same mark to omit its description.

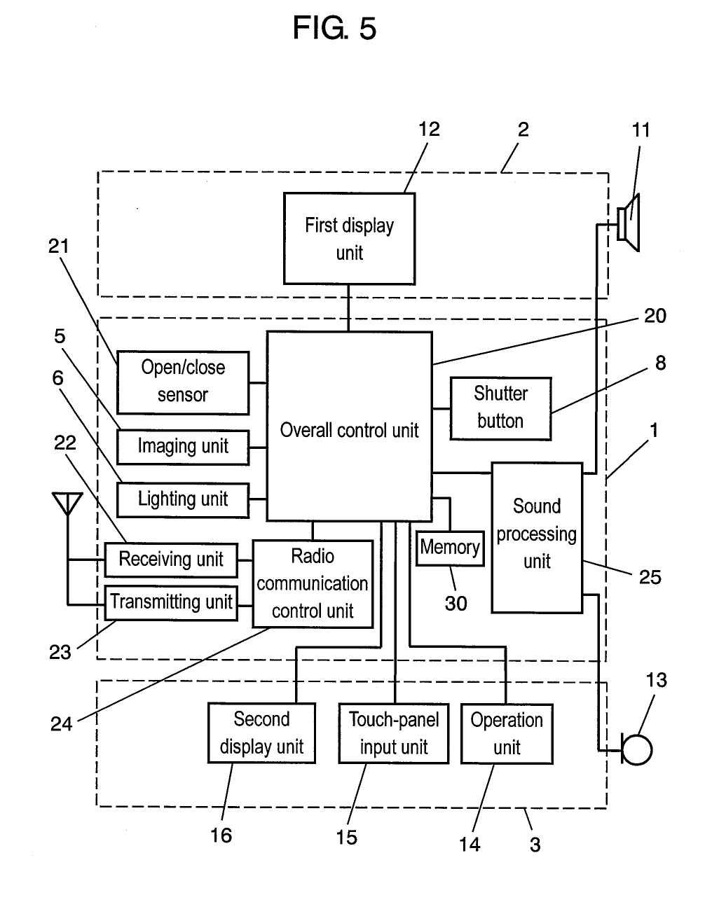

FIG. 5 is a block diagram illustrating the makeup of the cellular phone device according to the second embodiment of the present invention. First display unit 12, provided on first casing 1, displays images for previewing, recorded in the cellular phone device or transmitted from the other end of the line during communication, menus for the cellular phone or camera function, and the like. Second display unit 16, provided on third casing 3, displays images for previewing, recorded in the cellular phone device or transmitted from the other end of the line during communication, menus for the cellular phone or camera function, and the like. Touch-panel input unit 15 equipped on the third casing accepts an input from the user.

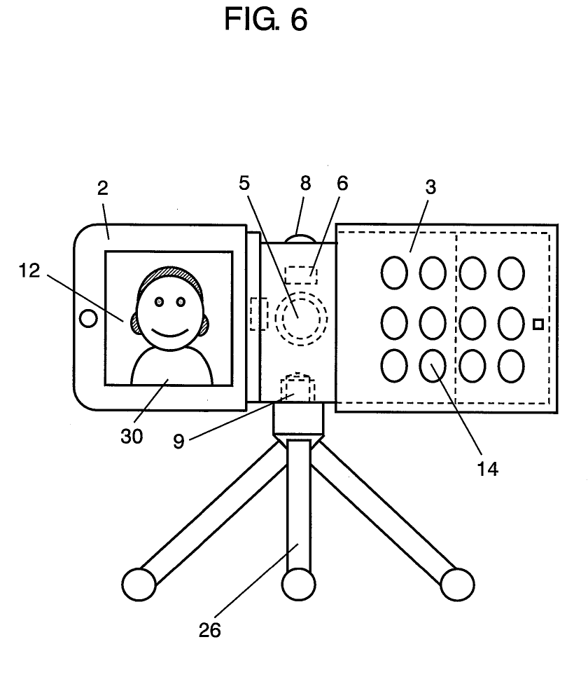

FIG. 6 is an external view of the cellular phone device according to the second embodiment, in the state of tripod 26 connected into tripod screw hole 9. Connecting tripod 26 into tripod screw hole 9 that appears when extending third casing 3 enables the cellular phone device to be fixed, thus preventing camera shake.

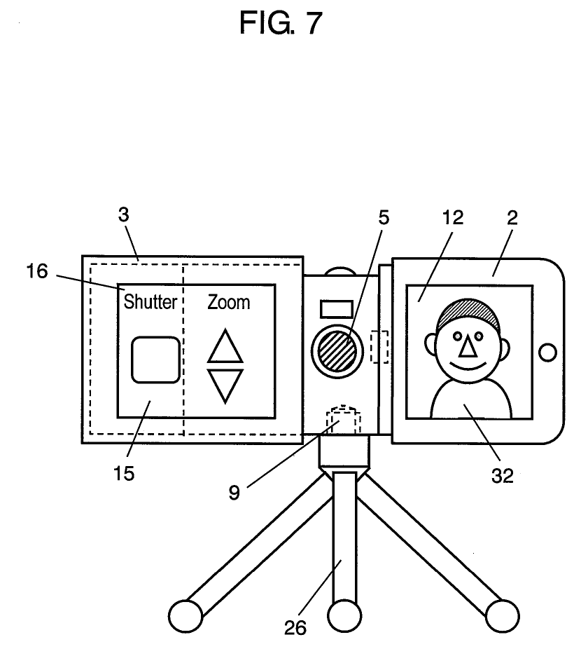

FIG. 7 is an external view of the cellular phone device according to the second embodiment, in a case of photographing a self-portrait of the user. Preview image 32 is a self-portrait or the like taken by imaging unit 5. Second display unit 16 displays information on operation such as zooming and shooting (shutter) at the bottom of touch-panel input unit 15 provided on the back surface of the operation unit on third casing 3. This makeup allows executing zooming and shooting using the touch-panel input unit, thus facilitating operation for photographing a self-portrait.

In this embodiment, the description is made only for the cases where imaging unit 5 is positioned at the opposite side of display unit 12 and at the same side. However, the present invention is not limited to these cases, namely photographing can be executed with display unit 12 rotated at an arbitrary angle easy-to-view from the user.

### Third Exemplary Embodiment

Next, a description is made for the third exemplary embodiment of the present invention. A cellular phone device of the embodiment is composed of first, second, and third casings. One side of the first casing slidably supports the third casing and additionally supports the third casing rotatably about the first casing. The other side of the first casing rotatably supports the second casing.

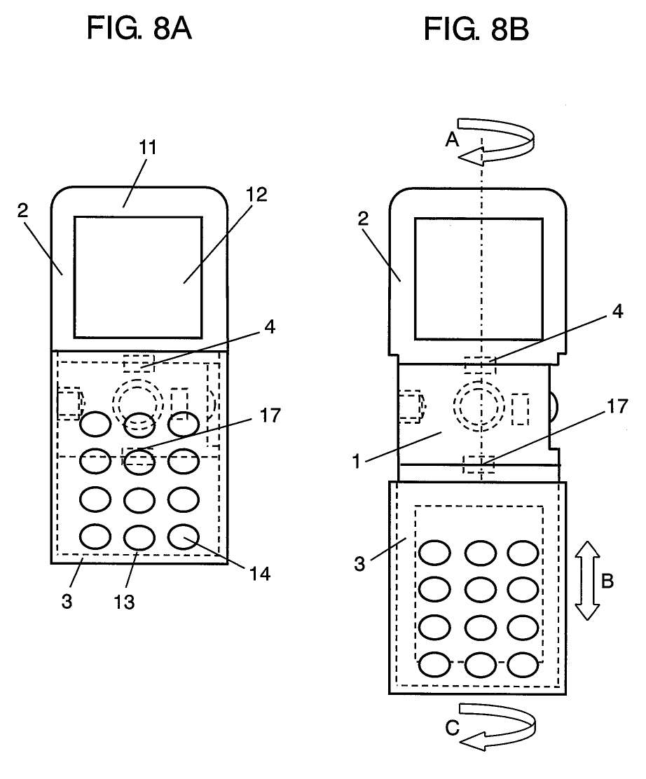

FIG. 8A is an external view of the cellular phone device according to the third embodiment of the present invention, in the state of the first casing contained in the third casing. FIG. 8B is an external view of the cellular phone device according to the third embodiment of the present invention, with the third casing extended.

The cellular phone device of the embodiment is composed of first casing 1, second casing 2, and third casing 3. One side of first casing 1 slidably supports third casing 3 while supporting third casing 3 rotatably about first casing 1 at an arbitrary angle by means of rotation axis 17. The other side of first casing 1 rotatably supports second casing 2.

Here, FIGS. 8A, 8B, 9A, 9B, and 10 show components common to those shown in the external view for the first embodiment, and thus the same component is given the same mark to omit its description.

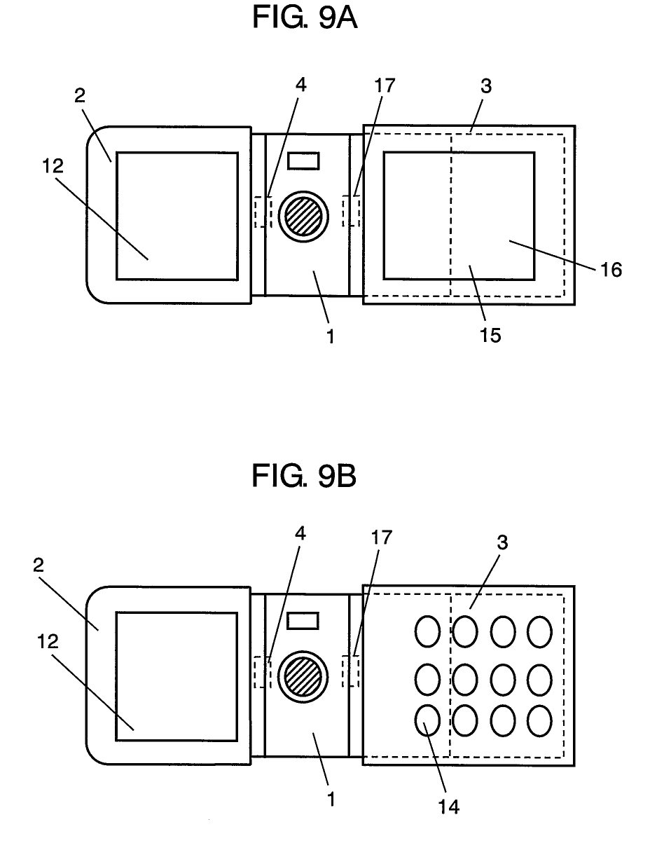

FIGS. 9A, 9B are external views for illustrating changes of the appearance of the cellular phone device according to the third embodiment of the present invention. FIG. 9A shows the state where first display unit 12 and second display unit 16 are rotated so as to face the same direction, with third casing 3 extended. FIG. 9B shows the state where first display unit 12 and second display unit 16 are rotated so as to face the opposite directions, with third casing 3 extended.

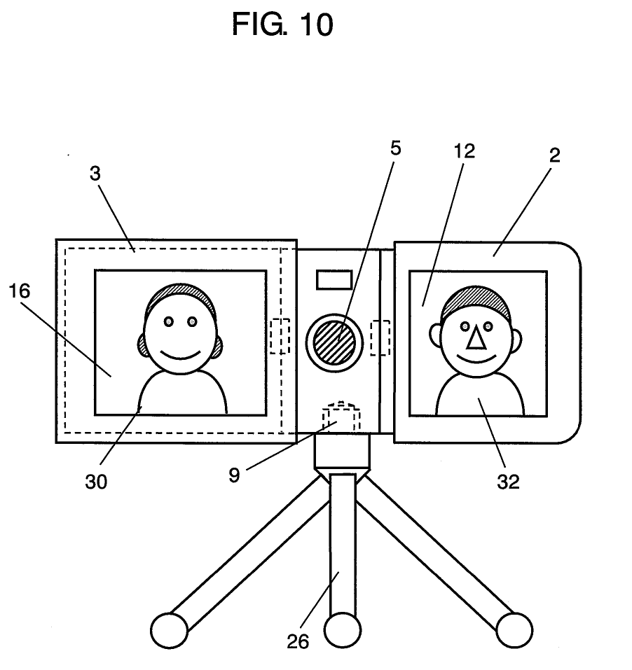

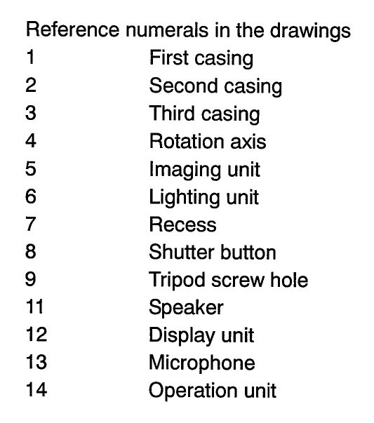

FIG. 10 is an external view of the cellular phone device according to the third embodiment, in the case where the device is used for a videophone. Own-end image 32 is an image taken by imaging unit 5, and other-end image 30 is an image transmitted by the other end of the line and received through a radio communication line. Second display unit 16 and first display unit 12 are used facing the same direction, thus enabling videophone communication while monitoring both own-end and other-end images displayed on the two displays simultaneously.

Here, in using the videophone function, own-end image 32 and other-end image 30 may be displayed on second display unit 16 and first display unit 12, respectively.

In this embodiment, the description is made only for the cases where imaging unit 5 is positioned at the opposite side of first display unit 12 and at the same side. However, the present invention is not limited to these cases, namely photographing can be executed with first display unit 12 rotated at an arbitrary angle easy-to-view from the user.

Further in this embodiment, the description is made only for the cases where imaging unit 5 is positioned at the opposite side of second display unit 16 and at the same side. However, the present invention is not limited to these cases, namely photographing can be executed with second display unit 16 rotated at an arbitrary angle easy-to-view from the user.

In this embodiment, the description is made for the application utilizing the videophone function. However, the present invention is not limited to this, namely may be applied to any image communication applications including chatting.

Further, in this embodiment, the description is made for the application utilizing the videophone function. However, the present invention is not limited to this, namely one display unit out of first display unit 12 and second display unit 16 may display one or more images stored in the cellular phone terminal, and the other display unit may display a preview image. The user can photograph while comparing a previous image and a preview image, which facilitates photographing a better image than the previous ones.

### INDUSTRIAL APPLICABILITY

A cellular phone device according to the present invention is useful for one having various types of functions such as imaging, videophone communication, and image communication, that improves the usability for the user when photographing a self-portrait while protecting the imaging unit from being soiled and damaged.

1. A cellular phone comprising:
a first casing, a second casing, and a third casing,
wherein one end of the first casing rotatably supports the second casing, an other end of the first casing slidably supports the third casing, the first casing has an imaging unit, and the imaging unit is contained in the third casing when the third casing is slided along the first casing and partially overlaps with the first casing.

2. The cellular phone of claim 1,
wherein the second casing has a display unit, and the display unit displays information according to rotation of the second casing in a state where the second casing is rotated about the first casing by an arbitrary angle.

3. The cellular phone of claim 1,
wherein a surface of the third casing is provided with a key operation unit, and a surface, which is opposite to the surface provided with the key operation unit, is provided with a touch-panel input unit, and
wherein a user can use the cellular phone by selecting one of allowing the user to key-input from the key operation unit on the third casing while the user views the display unit on the second casing by rotating the third casing with the display unit on the second casing being in front of the user; and allowing the user to touch-input from the touch-panel input unit on the third casing while the user views the display unit on the second casing.

4. The cellular phone of claim 3,
wherein the cellular phone can perform image communication, and
wherein one display unit out of the display unit provided on the second casing and the display unit provided at the touch-panel input unit on the third casing displays an image of an own end, and
an other display unit displays an image of an other end.

5. The cellular phone of claim 3,
wherein one display unit out of the display unit provided on the second casing and the display unit provided at the touch-panel input unit on the third casing displays an image stored in the cellular phone, and
an other display unit displays a preview image.

6. The cellular phone of claim 1,
wherein a side of the first casing has a screw hole for attaching a tripod.

7. The cellular phone of claim 2,
wherein a surface of the third casing is provided with a key operation unit, and a surface, which is opposite to the surface provided with the key operation unit, is provided with a touch-panel input unit, and
wherein a user can use the cellular phone by selecting one of allowing the user to key-input from the key operation unit on the third casing while the user views the display unit on the second casing by rotating the third casing with the display unit on the second casing being in front of the user; and allowing the user to touch-input from the touch-panel input unit on the third casing while the user views the display unit on the second casing.

8. The cellular phone of claim 7,
wherein the cellular phone can perform image communication, and
wherein one display unit out of the display unit provided on the second casing and the display unit provided at the touch-panel input unit on the third casing displays an image of an own end, and
an other display unit displays an image of an other end.

9. The cellular phone of claim 7,
wherein one display unit out of the display unit provided on the second casing and the display unit provided at the touch-panel input unit on the third casing displays an image stored in the cellular phone, and
an other display unit displays a preview image.
